(19) United States
(12) Patent Application Publication
(10) Pub. No.: US 2017/0106977 A1
(43) Pub. Date: Apr. 20, 2017

(54) Aircraft With Polygonal Wings

(71) Applicant: DANIELSON AIRCRAFT SYSTEMS, Magny Cours (FR)

(72) Inventor: Frédéric Hubschwerlen, Saint-Pierre-le-Moutier (FR)

(21) Appl. No.: 15/317,005

(22) PCT Filed: Jun. 10, 2015
(86) PCT No.: PCT/FR2015/051526

§ 371 Date: Dec. 7, 2016

(30) Foreign Application Priority Data
Jun. 10, 2014 (FR) 1455218

(51) Int. Cl. B64C 39/06; B64C 1/30; B64C 9/14; B64C 3/56; B64C 39/02; B64C 3/16

(52) U.S. Cl. CPC B64C 39/068; B64C 39/024; B64C 3/16; B64C 9/14; B64C 3/56; B64C 1/30; B64C 2201/021; B64C 2201/102; B64C 2201/127

(57) ABSTRACT

An aerial vehicle including at least two side fuselages interconnected via a wing, at least one propulsion mechanism, and two side wings extending from respective ones of the side fuselages. Each side wing has a section as seen from the front that is in the shape of a polygon having at least four sides. The ratio between the height of the side wings and the wingspan of the aerial vehicle is between 0.15 to 0.25. Each side wing has a first wing portion extending in the same plane as the wing, a second wing portion extending vertically above the first wing portion and inclined rearwards and upwards, a third wing portion extending parallel to the first wing portion and extending rearwards while forming an angle with the front plane of the aerial vehicle, and a fourth wing portion extending vertically down to the rear end of the side fuselage.

### FIELD OF THE INVENTION

The present invention relates to an aerial vehicle or to an Unmanned Aerial Vehicle (UAV), commonly known as a “drone”, that is compact, that has a long flight range, and that can take off and land on a short runway.

### BACKGROUND OF THE INVENTION

In the field of Unmanned Aerial Vehicles (UAVs), commonly known as “drones”, and also known as Unmanned Aircraft Systems (UASs), various types are known that can be put into two main categories, namely tactical fixed-wing aircraft, and Vertical Take-Off and Landing (VTOL) aircraft.

VTOL aircraft offer the advantage of being suitable for being flown from very small pieces of land. However, such aircraft suffer from the drawback of being particularly costly. Such aircraft are, in particular, described in U.S. Pat. No. 5,758,844 and US2009/0045295.

Document U.S. Pat. No. 5,758,844 describes an air vehicle including a fuselage, a plurality of lifting surfaces attached to the fuselage and having control devices attached to them, and an articulated propulsion system attached to the fuselage. Said propulsion system includes a duct assembly pivotally connected to the fuselage. The duct assembly comprises a duct and a propeller assembly mounted within said duct. A motor assembly is connected to the propeller assembly. The duct assembly may be positioned in a substantially vertical position to provide sufficient direct vertical thrust for vertical take-off and landing, and may be directed in other positions to provide a varying spectrum of take-off and landing configurations, as well as a substantially horizontal position for high-speed horizontal flight.

Document US2009/0045295 describes a Vertical/Short Take-Off and Landing (V/STOL) aircraft having a fuselage and a tiltable proprotor assembly that has a pair of in-line counter-rotating rotors. One of the engines is shut down in horizontal flight to improve flight efficiency. The aircraft also has a gimbal permitting thrust to be directed forward to back and left to right to control pitch and roll when hovering.

Tactical fixed-wing aircraft offer the advantage of being less costly but they suffer from the drawback of requiring long runways for take-off and landing. In order to mitigate that drawback, devices for launching such drones have been imagined, such as, for example take-off ramps. Such drones are, in particular, described in International Patent Application WO 2011/002331, for example.

Document WO2011/002331 describes a small unmanned aircraft for aerial surveillance and reconnaissance, which comprises a ground control station, on-board and ground radio-communication, navigation and flight control means, a launching device and an unmanned demountable aircraft that carries a payload, that has a modular structure, and that can be easily assembled for flight and disassembled for transport in a compact container, wherein the simplicity and reliability of the structure of the unmanned aircraft are increased while the weight thereof is reduced as a result of the innovative structure of the central spar of the fuselage and cam connections with locking members for attaching parts of the wing to the fuselage. The unmanned aircraft has the aerodynamic configuration of a flying wing with a propulsive propeller, an electric power unit and a parachute system for landing.

Unfortunately, that type of aircraft suffers from the drawback of having a short flight range and does not make it possible to take a large payload on board.

### SUMMARY OF THE INVENTION

One of the objects of the invention is thus to remedy those drawbacks by providing an unmanned aerial vehicle that is of simple design, that is inexpensive, that has a long flight range, that is compact, and that makes it possible to take a large payload on board, while requiring only a short runway for take-off and landing.

To this end, the invention provides a manned or unmanned aerial vehicle comprising at least one fuselage, two wings, and one propulsion means, said vehicle being remarkable in that it is constituted by at least two “side” fuselages, said side fuselages being interconnected via a wing, by at least one propulsion means, and by two “side” wings extending from respective ones of the side fuselages, each side wing having a section as seen from the front that is in the shape of a polygon having at least four sides.

Said propulsion means consists of two engines carried by respective ones of the side fuselages and driving respective propellers.

The axis of each propeller forms an angle, in a vertical fore-and-aft plane, with the plane of the wings and/or said wings have flaps having single, double, or triple slots in order to procure a blown wing.

In addition, the ratio between the height of the side wings and the wingspan of the aerial vehicle lies in the range 0.15 to 0.25, and is preferably equal to 0.2.

Secondarily, at least one of the sides of each of said side wings (5) is curved.

In addition, each side wing is constituted by a first wing portion extending substantially in the same plane as the wing connecting the side fuselages to the central fuselage, a second wing portion extending substantially vertically above the first wing portion and being inclined rearwards and upwards, a third wing portion extending substantially parallel to the first wing portion and extending rearwards while forming an angle with the front plane of the aircraft, and a fourth wing portion extending substantially vertically down to the rear end of the side fuselage.

The first wing portion of the side wing forms an angle lying in the range 1° to 10° with the wing connecting the side fuselages to the central fuselage.

The second wing portion forms an angle lying in the range 1° to 15° with a vertical fore-and-aft plane of the aerial vehicle.

The third wing portion forms an angle lying in the range 1° to 10° with the wing connecting the side fuselages to the central fuselage, and an angle lying in the range 1° to 10° with the first wing portion.

The fourth wing portion forms an angle lying in the range −1° to −10° with a vertical fore-and-aft plane of the aerial vehicle.

Secondarily, the wing connecting the side fuselages to the central fuselage is provided with hinge means making it possible to fold the side wings over above the central fuselage.

In a variant embodiment, the side fuselages and the second wing portions of the side wings are provided with hinge means so that the rear portions of the side fuselages can be folded over above the front portion of the side fuselages and so that the side wings can be folded over above the wing.

In addition, the longitudinal axis of the central fuselage extends below the wing interconnecting the side fuselages, and the engine traction axis of each side fuselage extends above the wing interconnecting the side fuselages.

In addition, in order to obtain good longitudinal stability for the aerial vehicle of the invention, the sweepback angle of the wing lies in the range 5° to 15°, and is preferably equal to 10°, and the sweepback angle of the third wing portion of each side wing lies in the range −10° to −30°, and is preferably equal to −20°.

### BRIEF DESCRIPTION OF THE DRAWINGS

Other advantages and characteristics appear more clearly from the following description of variant embodiments of the aerial vehicle of the invention that are given by way of non-limiting example, and with reference to the accompanying drawings, in which:

FIG. 1 is a view in perspective of the aerial vehicle of the invention;

FIG. 2 is a view from the front of the aerial vehicle of the invention;

FIG. 3 is a view from the side of the aerial vehicle of the invention;

FIG. 4 is a view from above of the aerial vehicle of the invention; and

FIG. 5 is a view in perspective of the aerial vehicle of the invention in the folded-away position.

### DETAILED DESCRIPTION OF THE INVENTION

In the description below of the unmanned aerial vehicle of the invention, like numerical references designate like elements. In addition, the various views are not necessarily drawn to scale.

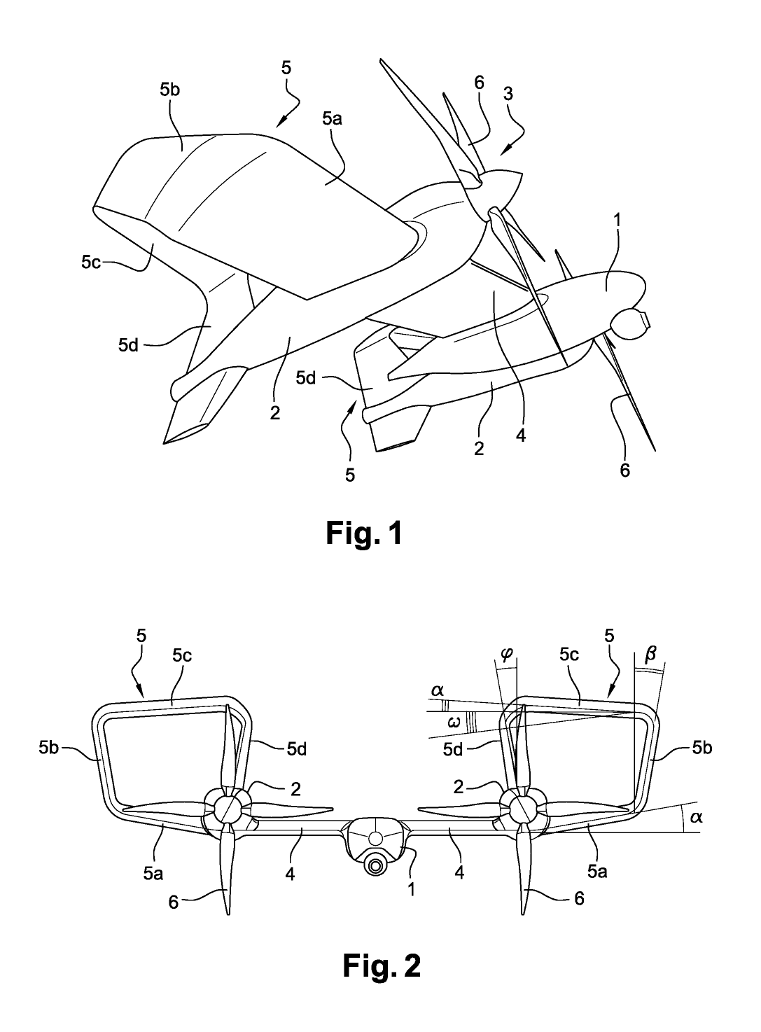

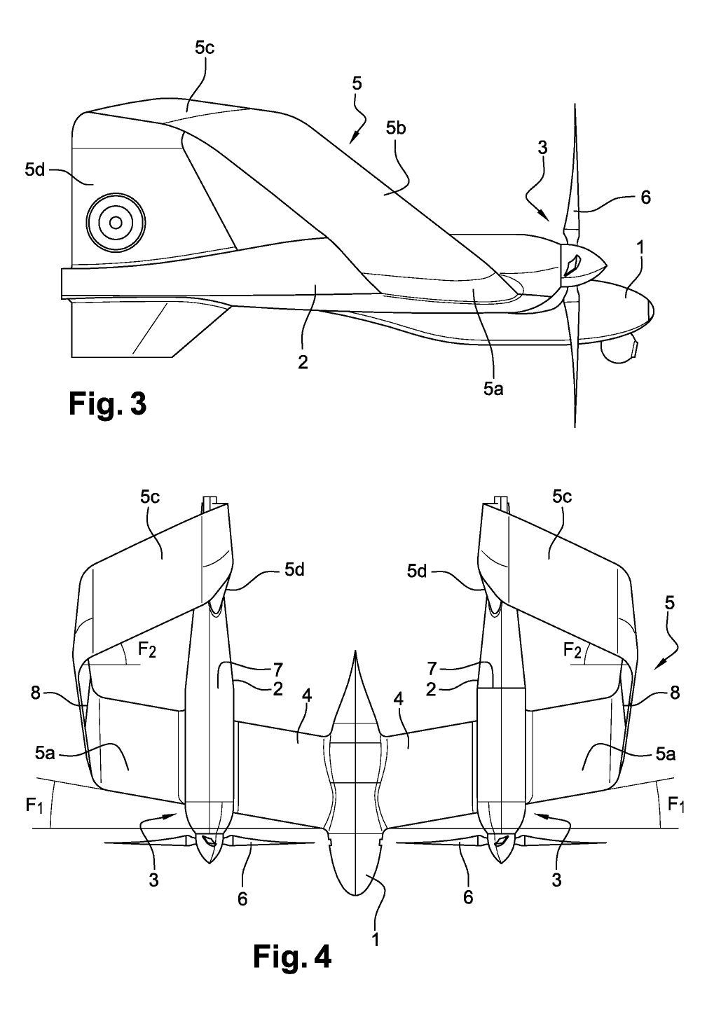

With reference to FIGS. 1 to 4, the unmanned aerial vehicle of the invention, commonly known as a “drone”, is constituted by a central fuselage (1) and two side fuselages (2) extending parallel to the central fuselage (1) and each carrying a respective propulsion means (3). Said side fuselages (2) are connected to the central fuselage (1) via a wing (4) inclined rearwards. The central fuselage (1) has a length less than the length of the side fuselages (2). In addition, the aerial vehicle also includes two “side” wings (5), each having a section as seen from the front that is in the shape of a quadrilateral extending from a respective one of said side fuselages (2). The longitudinal axis of the central fuselage (1) extends below the wing (4) connecting the side fuselages (2) to the central fuselage (1), and the engine traction axis extends above the wing (4) connecting the side fuselages (2) to the central fuselage (1).

It can be observed that the central fuselage (1) carries, in particular, on-board radio-communication, navigation, and flight control means that are not shown. Said central fuselage (1) may also carry surveillance means such as, for example, a camera, weapons means, etc. without going beyond the ambit of the invention.

In addition, it should be noted that the central fuselage (1) may be omitted from the aerial vehicle without going beyond the ambit of the invention.

In addition, each propulsion means (3) consists of an engine (not shown in the figures) driving a respective propeller (6) positioned at the front of the respective side fuselage (2). The axis of each propeller (6) forms an angle, in a vertical plane, with the plane of the wings and/or said wings have flaps having single, double, or triple slots in order to procure a “blown” wing. Thus, the propellers (6) blow directly almost all of the wings and considerably increase the lift in that zone. In this way, the aerial vehicle of the invention offers a very high lift coefficient making take-off possible over a short distance, of about 90 meters.

In addition, each side wing (5) is constituted by a first wing portion (5a) extending substantially in the same plane as the wing (4) connecting the side fuselages (2) to the central fuselage (1), a second wing portion (5b) extending substantially vertically above the first wing portion (5a) and being inclined rearwards and upwards, a third wing portion (5c) extending substantially parallel to the first wing portion (5a) and extending rearwards while forming an angle with the front plane of the aerial vehicle, and a fourth portion of wing (5d) extending substantially vertically down to the rear end of the side fuselage (2). In this particular embodiment, the first wing portion (5a) of the side wing (5) forms an angle α lying in the range 1° to 10° with the wing (4) connecting the side fuselages (2) to the central fuselage (1). The second wing portion (5b) forms an angle β lying in the range 1° to 15° with a vertical fore-and-aft plane of the aerial vehicle. The third wing portion (5c) forms an angle γ lying in the range 1° to 10° with the wing (4) connecting the side fuselages to the central fuselage, and an angle ω lying in the range 1° to 10° with the first wing portion (5a). The fourth wing portion (5d) forms an angle φ lying in the range −1° to −10° with a vertical fore-and-aft plane of the aerial vehicle. In addition, the ratio between the height of the side wings (5) and the wingspan of the aerial vehicle lies in the range 0.15 to 0.25, and is preferably equal to 0.2. The term “wingspan” is used to mean the distance between the outermost edges of the two side wings (5).

It can be observed that, in this particular embodiment, each side wing (5) is in the shape of a quadrilateral; however, naturally, each side wing (5) may be in the shape of any polygon whatsoever having at least four sides. Secondarily, at least one of the sides of each of said side wings may be curved.

In addition, in order to obtain good longitudinal stability for the aerial vehicle of the invention, the sweepback angle F₁ of the wing (4) lies in the range 5° to 15°, and is preferably equal to 10°, and the sweepback angle F₂ of the third wing portion (5c) of each side wing (5) lies in the range −10° to −30°, and is preferably equal to −20°.

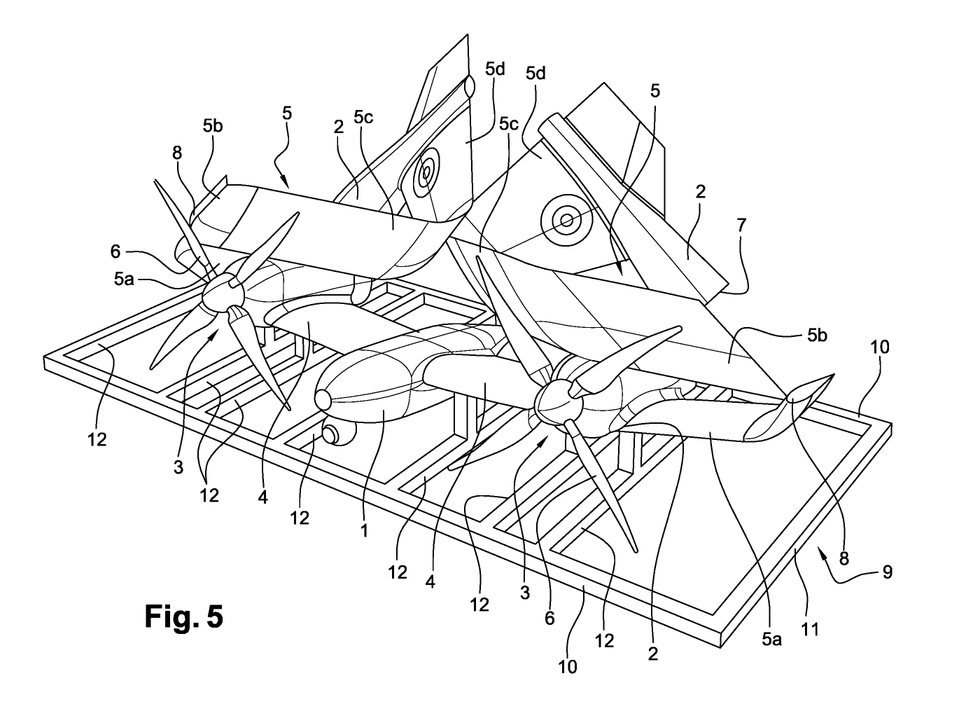

In advantageous manner, with reference to FIGS. 4 and 5, each of the side fuselages (2) is made up of two portions that are hinged by any hinge means (7) well known to the person skilled in the art, and the second wing portions (5b) of the side wings (5) are provided with hinge means (8) so that the rear portions of the side fuselages (2) can be folded over above the front portions of the side fuselages (2), and so that the side wings (5) can be folded over above the wing (4) (FIG. 5). Thus, it is possible to make the aerial vehicle more compact, e.g. while it is being transported to its operational site. To this end, the aerial vehicle may be positioned on a transport support constituted by a frame (9) made up of longitudinal members (10), transverse members (11), and crossbeams (12).

In a variant embodiment (not shown in the figures), the wing (4) connecting the side fuselages (2) to the central fuselage (1) has hinge means making it possible to fold the side wings (5) over above the central fuselage (1) in order to increase the compactness of the aerial vehicle while it is being transported to its operational site.

Naturally, said hinge means may consist of any hinge means well known to the person skilled in the art.

In addition, naturally the engines driving the propellers (6) preferably consist of internal combustion engines fed with fuel stored in reservoirs positioned in the side fuselages (2) and in the wings (4, 5). However said engines may also consist of electric motors without going beyond the ambit of the invention.

Finally, naturally the above-given examples are merely particular illustrations and in no way limit the field of application of the invention.

1. An aerial vehicle comprising at least two side fuselages interconnected via a wing, at least one propulsion means, and two side wings extending from respective ones of the side fuselages, each side wing having a section as seen from the front of said aerial vehicle that is in the shape of a polygon having at least four sides, said aerial vehicle being characterized in that:
each of the propulsion means comprises an engine carried by a respective side fuselage and driving a respective propeller;
a ratio between a height of the side wings and a wingspan of the aerial vehicle lies in the range 0.15 to 0.25;
each side wing is constituted by a first wing portion extending substantially in the same plane as the wing interconnecting the side fuselages, a second wing portion extending substantially vertically above the first wing portion and being inclined rearwards and upwards, a third wing portion extending substantially parallel to the first wing portion and extending rearwards while forming an angle with the front plane of the aerial vehicle, and a fourth wing portion extending substantially vertically down to the rear end of the side fuselage.

2. The aerial vehicle according to claim 1, characterized in that an axis of each propeller forms an angle, in a vertical fore-and-aft plane, with a plane of the wings.

3. The aerial vehicle according to claim 1, characterized in that said wings have flaps having single, double, or triple slots.

4. The aerial vehicle according to claim 1, characterized in that the ratio between the height of the side wings and the wingspan of the aerial vehicle is equal to 0.2.

5. The aerial vehicle according to claim 1, characterized in that at least one of the sides of each of said side wings is curved.

6. The aerial vehicle according to claim 1, characterized in that said aerial vehicle further comprises a central fuselage extending between the side fuselages.

7. The aerial vehicle according to claim 1, characterized in that the first wing portion of the side wing forms an angle α lying in the range 1° to 10° with the wing interconnecting the side fuselages.

8. The aerial vehicle according to claim 1, characterized in that the second wing portion forms an angle β lying in the range 1° to 15° with a vertical fore-and-aft plane of the aerial vehicle.

9. The aerial vehicle according to claim 6, characterized in that the third wing portion forms an angle γ lying in the range 1° to 10° with the wing connecting the side fuselages to the central fuselage, and an angle ω lying in the range 1° to 10° with the first wing portion.

10. The aerial vehicle according to claim 1, characterized in that the fourth wing portion forms an angle φ lying in the range −1° to −10° with a vertical fore-and-aft plane of the aerial vehicle.

11. The aerial vehicle according to claim 1, characterized in that the wing interconnecting the side fuselages is provided with hinge means making it possible to fold the side wings over above the wing.

12. The aerial vehicle according to claim 1, characterized in that the side fuselages and the second wing portions of the side wings are provided with hinge means so that the rear portions of the side fuselages can be folded over above the front portion of the side fuselages and so that the side wings can be folded over above the wing.

13. The aerial vehicle according to claim 6, characterized in that a longitudinal axis of the central fuselage extends below the wing interconnecting the side fuselages.

14. The aerial vehicle according to claim 1, characterized in that an engine traction axis extends above the wing interconnecting the side fuselages.

15. The aerial vehicle according to claim 1, characterized in that a sweepback angle of the wing lies in the range 5° to 15°.

16. The aerial vehicle according to claim 1, characterized in that the sweepback angle of the third wing portion of each side wing lies in the range −10° to −30°.

17. The aerial vehicle according to claim 15, characterized in that the sweepback angle of the wing is equal to 10°.

18. The aerial vehicle according to claim 16, characterized in that the sweepback angle of the third wing portion of each side wing is equal to −20°.
